(19) United States
(12) Patent Application Publication
(10) Pub. No.: US 2021/0258844 A1
(43) Pub. Date: Aug. 19, 2021

(54) DELAYED CELL GROUP CHANGE PROCEDURE

(71) Applicant: LG ELECTRONICS INC., Seoul (KR)

(72) Inventors: Hongsuk KIM, Seoul (KR); Sangwon KIM, Seoul (KR); Youngdae LEE, Seoul (KR)

(73) Assignee: LG ELECTRONICS INC., Seoul (KR)

(21) Appl. No.: 17/270,598

(22) PCT Filed: Sep. 30, 2019
(86) PCT No.: PCT/KR2019/012701

§ 371 Date: Feb. 23, 2021

(30) Foreign Application Priority Data
Sep. 28, 2018 (KR) 10-2018-0115571

(51) Int. Cl. H04W 36/00; H04W 36/30; H04W 36/08

(52) U.S. Cl. CPC H04W 36/00837; H04W 36/08; H04W 36/305; H04W 36/0058

(57) ABSTRACT

A method and apparatus for delayed Cell Group (CG) change procedure in a wireless communication system is provided. A wireless device triggers a measurement reporting based on a first event for a first cell, receives a cell group (CG) change command which commands CG change related to the first cell, and determines whether the CG change command is valid or not based on the first event for the first cell and/or a second event for a second cell other than the first cell.

### TECHNICAL FIELD

The present specification relates to delayed Cell Group (CG) change procedure.

### BACKGROUND

Wireless communication systems generally aim to reduce costs for users and providers, improve service quality, and expand and improve coverage and system capacity. To achieve these goals, in some scenarios, wireless communication systems are designed to reduced cost per bit, increased service availability, flexible use of a frequency band, a simple structure, an open interface, and adequate power consumption of a terminal as an upper-level requirement.

### SUMMARY

It has been discussed to support Non-Terrestrial Network (NTN) in 5G NR. The NTN is commonly used to support transport, public safety, media and entertainment, eHealth, energy, agriculture, finance, automotive, etc.

Even though there are some beneficial point to apply NTN service in 5G NR, there are also several issues that need to be addressed. As one of the several issues, propagation delay should be considered. More specifically, signaling delay for Cell Group (CG) change in NTN should be handled.

In an aspect, a method performed by a wireless device in a wireless communication system is provided. The method includes triggering a measurement reporting based on a first event for a first cell, receiving a cell group (CG) change command which commands CG change related to the first cell, and determining whether the CG change command is valid or not based on the first event for the first cell and/or a second event for a second cell other than the first cell.

In another aspect, an apparatus for implementing the above method is provided.

The present specification can have various advantageous effects.

For example, a wireless device can inform a network that a mobility to a cell which is no more applicable due to propagation delay is invalid.

For example, the wireless device can prevent additional CG change failure by not perform CG mobility to a cell which is no more applicable to perform CG change.

For example, CG change failure rate can be reduced and terminal service delay can be minimized by preventing improper mobility procedures due to propagation delays that can occur frequently due to satellite service.

Advantageous effects which can be obtained through specific embodiments of the present specification are not limited to the advantageous effects listed above. For example, there may be a variety of technical effects that a person having ordinary skill in the related art can understand and/or derive from the present specification. Accordingly, the specific effects of the present specification are not limited to those explicitly described herein, but may include various effects that may be understood or derived from the technical features of the present specification.

### BRIEF DESCRIPTION OF THE DRAWINGS

FIG. 1 shows an example of a communication system to which the technical features of the present specification can be applied.

FIG. 2 shows an example of wireless devices to which the technical features of the present specification can be applied.

FIG. 3 shows an example of a signal processing circuit for a transmission signal to which the technical features of the present specification can be applied.

FIG. 4 shows another example of a wireless device to which the technical features of the present specification can be applied.

FIG. 5 shows an example of a hand-held device to which the technical features of the present specification can be applied.

FIG. 6 shows an example of a wireless communication system to which the technical features of the present specification can be applied.

FIG. 7 shows another example of a wireless communication system to which the technical features of the present specification can be applied.

FIG. 8 shows a block diagram of a user plane protocol stack to which the technical features of the present specification can be applied.

FIG. 9 shows a block diagram of a control plane protocol stack to which the technical features of the present specification can be applied.

FIG. 10 shows an example of NTN typical scenario to which the technical features of the present specification can be applied.

FIG. 11 shows an example of propagation delay problem in NTN.

FIG. 12 shows an example of a method for performing delayed CG change procedure according to an embodiment of the present specification.

FIG. 13 shows an example of a method for performing delayed SCG change procedure according to an embodiment of the present specification.

FIG. 14 shows an example of an AI device to which the technical features of the present specification can be applied.

FIG. 15 shows an example of an AI system to which the technical features of the present specification can be applied.

### DETAILED DESCRIPTION

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (UL). For example, only OFDMA may be used for DL and only SC-FDMA may be used for UL. Alternatively, OFDMA and SC-FDMA may be used for DL and/or UL.

The following drawings are created to explain specific embodiments of the present specification. The names of the specific devices or the names of the specific signals/messages/fields shown in the drawings are provided by way of example, and thus the technical features of the present specification are not limited to the specific names used in the following drawings.

An example of a communication system to which the technical features of the present specification can be applied is described.

Although not limited thereto, various descriptions, functions, procedures, suggestions, methods and/or operational flowcharts of the present specification disclosed herein can be applied to various fields requiring wireless communication and/or connection (e.g., 5G) between devices.

Hereinafter, the present specification will be described in more detail with reference to drawings. The same reference numerals in the following drawings and/or descriptions may refer to the same and/or corresponding hardware blocks, software blocks, and/or functional blocks unless otherwise indicated.

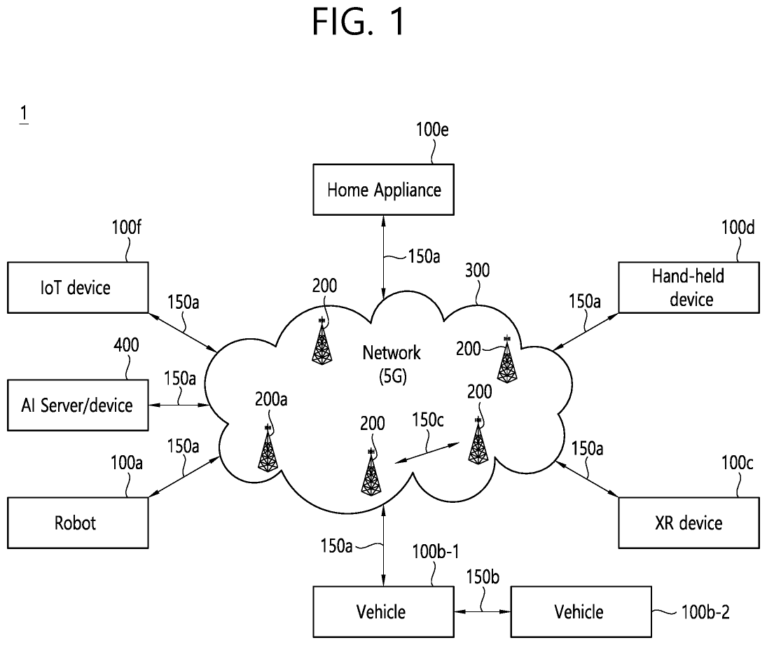

FIG. 1 shows an example of a communication system to which the technical features of the present specification can be applied.

Referring to FIG. 1, a communication system 1 to which the technical features of the present specification can be applied includes a wireless device, a base station and a network. Here, the wireless device refers to a device that performs communication using a radio access technology (e.g., 5G new radio access technology (NR), long-term evolution (LTE)), and may be referred to as a communication/wireless/5G device. Although not limited thereto, the wireless device may include a robot 100a, a vehicle 100b-1, 100b-2, an extended reality (XR) device 100c, a hand-held device 100d, a home appliance 100e, an internet of things (IoT) device 100f and an artificial intelligence (AI) device/server 400. For example, the vehicle may include a vehicle having a wireless communication function, an autonomous vehicle, a vehicle capable of performing inter-vehicle communication, etc. Here, the vehicle may include an unmanned aerial vehicle (UAV) (e.g., a drone). The XR device may include augmented reality (AR)/virtual reality (VR)/mixed reality (MR) devices. The XR device may be implemented in the form of head-mounted device (HMD), head-up display (HUD) provided in a vehicle, a television, a smartphone, a computer, a wearable device, a home appliance, a digital signage, a vehicle, a robot, etc. The hand-held device may include a smartphone, a smart pad, a wearable device (e.g., a smart watch, smart glasses), a computer (e.g., a laptop, etc.). The home appliance may include a TV, a refrigerator, a washing machine, etc. The IoT device may include a sensor, a smart meter, etc. For example, the base station and the network may be implemented as a wireless device. A specific wireless device 200a may operate as a base station/network node to other wireless devices.

The wireless devices 100a to 100f may be connected to the network 300 through the base station 200. AI technology may be applied to the wireless devices 100a to 100f, and the wireless devices 100a to 100f may be connected to the AI server 400 through the network 300. The network 300 may be configured using a 3G network, a 4G (e.g., LTE) network and/or a 5G (e.g., NR) network. The wireless devices 100a to 100f may communicate with each other via the base station 200/network 300, but may also communicate directly (e.g., sidelink communication) without passing through the base station 200/network 300. For example, the vehicles 100b-1 and 100b-2 may perform direct communication (e.g., vehicle-to-vehicle (V2V)/vehicle-to-everything (V2X) communication). In addition, the IoT device (e.g., sensor) may directly communicate with another IoT device (e.g., sensor) or another wireless device 100a to 100f.

Wireless communication/connections 150a, 150b, and 150c may be performed between the wireless devices 100a to 100f and the base station 200 and/or between the base stations 200. Here, the wireless communication/connection may be performed by various wireless access technologies (e.g., 5G NR) such as uplink/downlink communication 150a, sidelink communication (or device-to-device (D2D)) communication) 150b, inter-base station communication 150c (e.g., relay, integrated access and backhaul (IAB)), etc. The wireless device and the base station/wireless device and/or the base stations may transmit/receive wireless signals with each other respectively through the wireless communication/connection 150a, 150b, and 150c. For example, wireless communications/connections 150a, 150b, and 150c may transmit/receive signals over various physical channels. To this end, based on various proposals of the present specification, at least some of various configuration information setting processes, various signal processing processes (e.g., channel encoding/decoding, modulation/demodulation, resource mapping/de-mapping, etc.), and resource allocation process for transmitting/receiving a wireless signal may be performed.

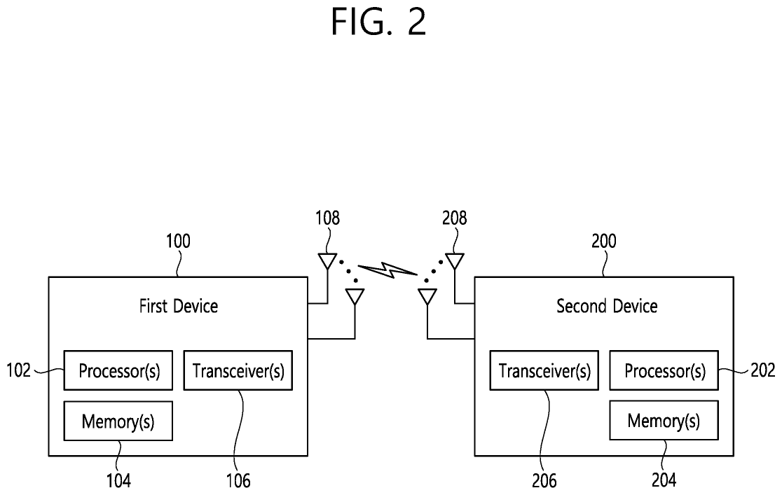

FIG. 2 shows an example of wireless devices to which the technical features of the present specification can be applied.

Referring to FIG. 2, the first wireless device 100 and the second wireless device 200 may transmit and receive wireless signals through various wireless access technologies (e.g., LTE, NR). Here, {the first wireless device 100 and the second wireless device 200} may correspond to {the wireless device 100x, the base station 200} and/or {the wireless device 100x, the wireless device 100x} in FIG. 1.

The first wireless device 100 may include one or more processors 102 and one or more memories 104. The first wireless device 100 may further include one or more transceivers 106 and/or one or more antennas 108. The processor 102 may control the memory 104 and/or the transceiver 106. The processor 102 may be configured to implement the descriptions, functions, procedures, suggestions, methods and/or operational flowcharts disclosed herein. For example, the processor 102 may process information in the memory 104 to generate the first information/signal, and then transmit a wireless signal including the first information/signal through the transceiver 106. In addition, the processor 102 may receive a wireless signal including the second information/signal through the transceiver 106 and then store information obtained from signal processing of the second information/signal in the memory 104. The memory 104 may be coupled to the processor 102 and may store various information related to the operation of the processor 102. For example, the memory 104 may include software code that includes instructions for performing some or all of the processes controlled by the processor 102 and/or for carrying out the descriptions, functions, procedures, suggestions, methods and/or operational flowcharts disclosed herein. Here, processor 102 and memory 104 may be part of a communication modem/circuit/chip designed to implement wireless communication technology (e.g., LTE, NR). The transceiver 106 may be coupled with the processor 102 and may transmit and/or receive wireless signals via one or more antennas 108. The transceiver 106 may include a transmitter and/or a receiver. The transceiver 106 may be mixed with a radio frequency (RF) unit. In the present specification, a wireless device may mean a communication modem/circuit/chip.

The second wireless device 200 may include one or more processors 202 and one or more memories 204. The second wireless device 200 may further include one or more transceivers 206 and/or one or more antennas 208. The processor 202 may control the memory 204 and/or the transceiver 206. The processor 202 may be configured to implement the descriptions, functions, procedures, suggestions, methods and/or operational flowcharts disclosed herein. For example, the processor 202 may process information in the memory 204 to generate the third information/signal, and then transmit a wireless signal including the third information/signal through the transceiver 206. In addition, the processor 202 may receive a wireless signal including the fourth information/signal through the transceiver 206 and then store information obtained from signal processing of the fourth information/signal in the memory 204. The memory 204 may be coupled to the processor 202 and may store various information related to the operation of the processor 202. For example, the memory 204 may include software code that includes instructions for performing some or all of the processes controlled by the processor 202 and/or for carrying out the descriptions, functions, procedures, suggestions, methods and/or operational flowcharts disclosed herein. Here, processor 202 and memory 204 may be part of a communication modem/circuit/chip designed to implement wireless communication technology (e.g., LTE, NR). The transceiver 206 may be coupled with the processor 202 and may transmit and/or receive wireless signals via one or more antennas 208. The transceiver 206 may include a transmitter and/or a receiver. The transceiver 206 may be mixed with an RF unit. In the present specification, a wireless device may mean a communication modem/circuit/chip.

Hereinafter, hardware elements of the wireless devices 100, 200 will be described in more detail. Although not limited thereto, one or more protocol layers may be implemented by one or more processors 102, 202. For example, one or more processors 102, 202 may implement one or more layers (e.g., functional layers such as physical (PHY), media access control (MAC), radio link control (RLC), packet data convergence protocol (PDCP), service data adaptation protocol (SDAP), radio resource control (RRC)). One or more processors 102, 202 may generate one or more protocol data units (PDUs) and/or one or more service data units (SDUs) in accordance with the descriptions, functions, procedures, suggestions, methods and/or operational flowcharts disclosed herein. One or more processors 102, 202 may generate messages, control information, data, or information in accordance with the descriptions, functions, procedures, suggestions, methods and/or operational flowcharts disclosed herein. One or more processors 102, 202 may generate signals (e.g., baseband signals) including PDUs, SDUs, messages, control information, data or information in accordance with the descriptions, functions, procedures, suggestions, methods and/or operational flowcharts disclosed herein, and provide to one or more transceivers 106, 206. One or more processors 102, 202 may receive signals (e.g., baseband signals) from one or more transceivers 106, 206, and obtain PDUs, SDUs, messages, control information, data or information in accordance with the descriptions, functions, procedures, suggestions, methods and/or operational flowcharts disclosed herein.

One or more processors 102, 202 may be referred to as a controller, a microcontroller, a microprocessor, and/or a microcomputer. One or more processors 102, 202 may be implemented by hardware, firmware, software, and/or a combination thereof. For example, one or more application specific integrated circuits (ASICs), one or more digital signal processors (DSPs), one or more digital signal processing devices (DSPDs), one or more programmable logic devices (PLDs), and/or one or more field programmable gate arrays (FPGAs) may be included in one or more processors 102, 202. The descriptions, functions, procedures, suggestions, methods and/or operational flowcharts disclosed herein may be implemented using firmware and/or software, and the firmware and/or software may be implemented to include modules, procedures, functions, etc. Firmware and/or software configured to perform the descriptions, functions, procedures, suggestions, methods and/or operational flowcharts disclosed herein may be included in one or more processors 102, 202 or stored in one or more memories 104, 204 and may be driven by one or more processors 102, 202. The descriptions, functions, procedures, suggestions, methods and/or operational flowcharts disclosed herein may be implemented using firmware or software in the form of code, instructions and/or a set of instructions.

One or more memories 104, 204 may be coupled with one or more processors 102, 202 and may store various forms of data, signals, messages, information, programs, codes, instructions, and/or commands. One or more memories 104, 204 may be comprised of a read-only memory (ROM), a random access memory (RAM), an erasable programmable read-only memory (EPROM), a flash memory, a hard drive, a register, a cache memory, a computer readable storage medium and/or combinations thereof. One or more memories 104, 204 may be located inside and/or outside one or more processors 102, 202. In addition, one or more memories 104, 204 may be coupled to one or more processors 102, 202 through various techniques, such as a wired and/or wireless connection.

One or more transceivers 106, 206 may transmit user data, control information, wireless signals/channels, etc., as mentioned in the descriptions, functions, procedures, suggestions, methods and/or operational flowcharts disclosed herein, to one or more other devices. One or more transceivers 106, 206 may receive user data, control information, wireless signals/channels, etc., as mentioned in the descriptions, functions, procedures, suggestions, methods and/or operational flowcharts disclosed herein, from one or more other devices. For example, one or more transceivers 106, 206 may be coupled with one or more processors 102, 202 and may transmit and/or receive wireless signals. For example, one or more processors 102, 202 may control one or more transceivers 106, 206 to transmit user data, control information, wireless signals/channels, etc., to one or more other devices. In addition, one or more processors 102, 202 may control one or more transceivers 106, 206 to receive user data, control information, wireless signals/channels, etc., from one or more other devices. In addition, one or more transceivers 106, 206 may be coupled to one or more antennas 108, 208. One or more transceivers 106, 206 may be configured to transmit and/or receive user data, control information, wireless signals/channels, etc., as mentioned in the descriptions, functions, procedures, suggestions, methods and/or operational flowcharts disclosed herein, through one or more antennas 108, 208. In this document, one or more antennas 108, 208 may be a plurality of physical antennas and/or a plurality of logical antennas (e.g., antenna ports). In order to process the received user data, control information, wireless signals/channels, etc., using one or more processors 102, 202, one or more transceivers 106, 206 may convert the received user data, control information, wireless signals/channels, etc., from an RF band signal to a baseband signal. One or more transceivers 106, 206 may convert user data, control information, wireless signals/channels, etc., processed by using one or more processors 102, 202, from a baseband signal to an RF band signal. To this end, one or more transceivers 106, 206 may include (analog) oscillators and/or filters.

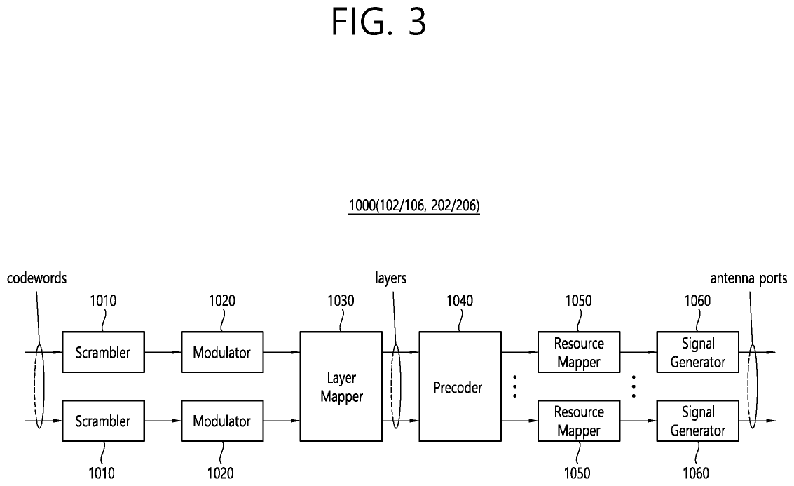

FIG. 3 shows an example of a signal processing circuit for a transmission signal to which the technical features of the present specification can be applied.

Referring to FIG. 3, the signal processing circuit 1000 may include a scrambler 1010, a modulator 1020, a layer mapper 1030, a recoder 1040, a resource mapper 1050, and a signal generator 1060. Although not limited thereto, operations/functions of FIG. 3 may be performed in processors 102, 202 and/or transceivers 106, 206 of FIG. 2. The hardware element of FIG. 3 may be implemented in processors 102, 202 and/or transceivers 106, 206 of FIG. 2. For example, blocks 1010 to 1060 may be implemented in processors 102, 202 of FIG. 2. Further, blocks 1010 to 1050 may be implemented in processors 102, 202 of FIG. 2, and block 1060 may be implemented in transceivers 106, 206 of FIG. 2.

The codeword may be converted into a wireless signal via the signal processing circuit 1000 of FIG. 3. Here, the codeword is a coded bit sequence of the information block. The information block may include a transport block (e.g., an uplink shared channel (UL-SCH) transport block, a downlink shared channel (DL-SCH) transport block). The wireless signal may be transmitted through various physical channels (e.g., physical uplink shared channel (PUSCH), physical downlink shared channel (PDSCH)).

In detail, the codeword may be converted into a scrambled bit sequence by the scrambler 1010. The scramble bit sequence used for scrambling may be generated based on initialization value, and the initialization value may include ID information of the wireless device, etc. The scrambled bit sequence may be modulated into a modulation symbol sequence by the modulator 1020. The modulation scheme may include pi/2-binary phase shift keying (pi/2-BPSK), m-phase shift keying (m-PSK), m-quadrature amplitude modulation (m-QAM), etc. The complex modulation symbol sequence may be mapped to one or more transport layers by the layer mapper 1030. The modulation symbols of each transport layer may be mapped to the corresponding antenna port(s) by the precoder 1040 (precoding). The output z of the precoder 1040 may be obtained by multiplying the output y of the layer mapper 1030 with the precoding matrix W of N*M. Here, N is the number of antenna ports and M is the number of transport layers. Here, the precoder 1040 may perform precoding after performing transform precoding (e.g., discrete Fourier transform (DFT)) on the complex modulation symbols. Also, the precoder 1040 may perform precoding without performing transform precoding.

The resource mapper 1050 may map modulation symbols of each antenna port to time-frequency resources. The time-frequency resource may include a plurality of symbols (e.g., cyclic prefix based OFDMA (CP-OFDMA) symbols, DFT spread OFDMA (DFT-s-OFDMA) symbols) in the time domain, and may include a plurality of subcarriers in the frequency domain. The signal generator 1060 may generate a wireless signal from the mapped modulation symbols, and the generated wireless signal may be transmitted to another device through each antenna. To this end, the signal generator 1060 may include an inverse fast Fourier transform (IFFT) module, a cyclic prefix (CP) inserter, a digital-to-analog converter (DAC), a frequency uplink converter, etc.

The signal processing procedure for a reception signal in the wireless device may be configured in the reverse of the signal processing procedure 1010 to 1060 of FIG. 3. For example, a wireless device (e.g., 100, 200 of FIG. 2) may receive a wireless signal from the outside through an antenna port/transceiver. The received wireless signal may be converted into a baseband signal through a signal recoverer. To this end, the signal recoverer may include a frequency downlink converter, an analog-to-digital converter (ADC), a CP canceller, and a fast Fourier transform (FFT) module. Thereafter, the baseband signal may be restored to a codeword through a resource de-mapper process, a postcoding process, a demodulation process, and a de-scrambling process. The codeword may be restored to the original information block through decoding. Thus, the signal processing circuit for the reception signal (not shown) may include a signal recoverer, a resource de-mapper, a postcoder, a demodulator, a de-scrambler and a decoder.

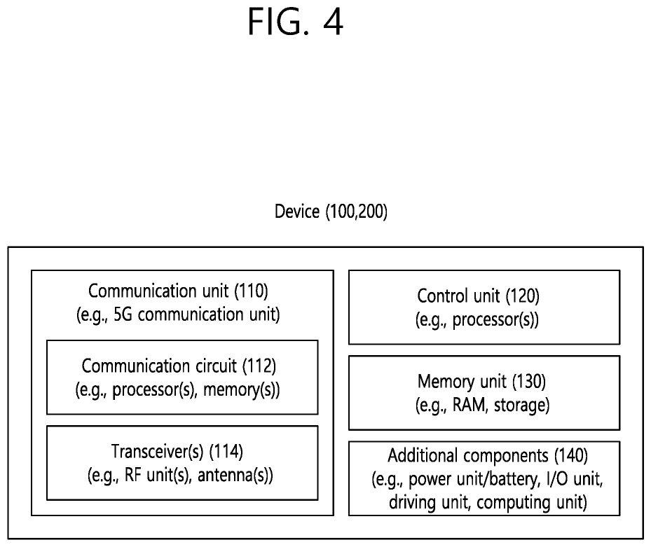

FIG. 4 shows another example of a wireless device to which the technical features of the present specification can be applied.

The wireless device may be implemented in various forms depending on use cases/services (see FIG. 1). Referring to FIG. 4, the wireless devices 100, 200 may correspond to the wireless devices 100, 200 of FIG. 2, and may be composed of various elements, components, units, and/or modules. For example, the wireless device 100, 200 may include a communication unit 110, a control unit 120, a memory unit 130, and additional components 140. The communication unit 110 may include a communication circuitry 112 and transceiver(s) 114. For example, the communication circuitry 112 may include one or more processors 102, 202 and/or one or more memories 104, 204 of FIG. 2. For example, the transceiver(s) 114 may include one or more transceivers 106, 206 and/or one or more antennas 108, 208 of FIG. 2. The control unit 120 is electrically connected to the communication unit 110, the memory unit 130, and the additional components 140, and controls various operations of the wireless device 100, 200. For example, the control unit 120 may control the electrical/mechanical operation of the wireless device 100, 200 based on the program/code/command/information stored in the memory unit 130. In addition, the control unit 120 may transmit the information stored in the memory unit 130 to the outside (e.g., other communication devices) through the communication unit 110 through a wireless/wired interface, or may store the information received from the outside (e.g., other communication devices) through the wireless/wired interface through the communication unit 110 in the memory unit 130.

The additional components 140 may be variously configured according to the type of the wireless device 100, 200. For example, the additional components 140 may include at least one of a power unit/battery, an input/output (I/O) unit, a driver, or a computing unit. Although not limited thereto, the wireless devices 100, 200 may be implemented in the form of robots (FIG. 1, 100a), vehicles (FIG. 1, 100b-1, 100b-2), XR devices (FIG. 1, 100c), hand-held devices (FIG. 1, 100d), home appliances (FIG. 1, 100e), IoT devices (FIG. 1, 1000, terminals for digital broadcasting, hologram devices, public safety devices, machine-type communication (MTC) devices, medical devices, fin-tech devices (or financial devices), security devices, climate/environment devices, an AI server/devices (FIG. 1, 400), a base station (FIG. 1, 200), a network node, etc. The wireless device 100, 200 may be used in a mobile or fixed location depending on use cases/services.

In FIG. 4, various elements, components, units, and/or modules within the wireless device 100, 200 may be entirely interconnected via a wired interface, or at least a part of the wireless device 100, 200 may be wirelessly connected through the communication unit 110. For example, in the wireless device 100, 200, the control unit 120 and the communication unit 110 may be connected by wire, and the control unit 120 and the first unit (e.g., 130, 140) may be wirelessly connected through the communication unit 110. In addition, each element, component, unit, and/or module in the wireless device 100, 200 may further include one or more elements. For example, the control unit 120 may be composed of one or more processor sets. For example, the control unit 120 may be configured as a set of a communication control processor, an application processor (AP), an electronic control unit (ECU), a graphics processing processor, a memory control processor, etc. As another example, the memory unit 130 may include RAM, a dynamic RAM (DRAM), ROM, a flash memory, a volatile memory, a non-volatile memory, and/or combinations thereof.

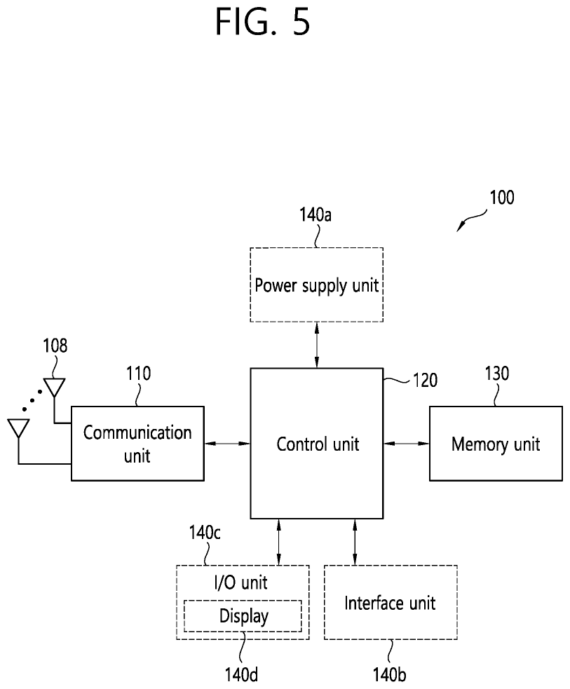

FIG. 5 shows an example of a hand-held device to which the technical features of the present specification can be applied.

The hand-held device 100 may include a smart phone, a smart pad, a wearable device (e.g., a smart watch, smart glasses), a portable computer (e.g., a notebook, etc.). The hand-held device 100 may be referred to as a mobile station (MS), a user terminal (UT), a mobile subscriber station (MSS), a subscriber station (SS), an advanced mobile station (AMS), or a wireless terminal (WT).

Referring to FIG. 5, the hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c may correspond to blocks 110 to 130/140 of FIG. 4, respectively.

The communication unit 110 may transmit and/or receive signals (e.g., data, control signals, etc.) with other wireless devices and base stations. The control unit 120 may control various components of the hand-held device 100 to perform various operations. The control unit 120 may include an AP. The memory unit 130 may store data, parameters, programs, codes and/or commands necessary for driving the hand-held device 100. In addition, the memory unit 130 may store input/output data/information, etc. The power supply unit 140a may supply power to the hand-held device 100 and may include a wired/wireless charging circuit, a battery, etc. The interface unit 140b may support connection of the hand-held device 100 to another external device. The interface unit 140b may include various ports (e.g., audio input/output ports, video input/output ports, etc.) for connecting to an external device. The I/O unit 140c may receive and/or output image information/signal, audio information/signal, data and/or information input from a user. The I/O unit 140c may include a camera, a microphone, a user input unit, a display unit 140d, a speaker and/or a haptic module.

For example, in case of data communication, the I/O unit 140c may obtain information/signals (e.g., touch, text, voice, image, and video) input from the user, and the obtained information/signals may be stored in the memory unit 130. The communication unit 110 may convert the information/signals stored in the memory unit 130 into a wireless signal. The communication unit 110 may directly transmit the converted wireless signal to another wireless device or may transmit the converted wireless signal to a base station. In addition, the communication unit 110 may receive a wireless signal from another wireless device or a base station, and then restore the received wireless signal to original information/signal. The restored information/signal may be stored in the memory unit 130 and then output in various forms (e.g., text, voice, image, video, and haptic) through the I/O unit 140c.

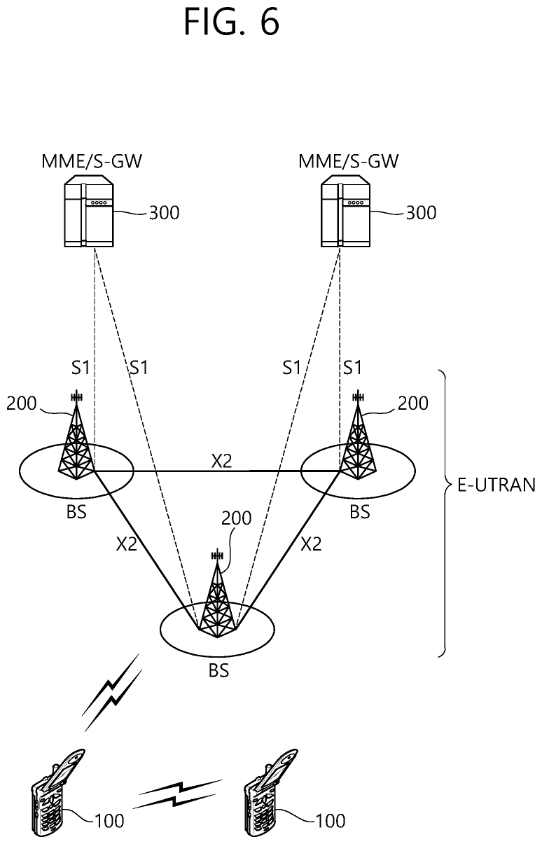

FIG. 6 shows an example of a wireless communication system to which the technical features of the present specification can be applied.

Specifically, FIG. 6 shows a system architecture based on an evolved-UMTS terrestrial radio access network (E-UTRAN). The aforementioned LTE is a part of an evolved-UTMS (e-UMTS) using the E-UTRAN.

Referring to FIG. 6, the wireless communication system includes one or more user equipment (UE) 100, an E-UTRAN and an evolved packet core (EPC). The UE 100 refers to a communication equipment carried by a user. The UE 100 may be fixed or mobile. The UE 100 may be referred to as another terminology, such as MS, UT, SS, a wireless device, etc. The UE 100 may correspond to the wireless device 100x of FIG. 1, the first wireless device 100 of FIG. 2, the wireless device 100 of FIG. 4, or the hand-held device 100 of FIG. 5.

The E-UTRAN consists of one or more evolved NodeB (eNB) 200. The eNB 200 provides the E-UTRA user plane and control plane protocol terminations towards the UE 100. The eNB 200 is generally a fixed station that communicates with the UE 100. The eNB 200 hosts the functions, such as inter-cell radio resource management (RRM), radio bearer (RB) control, connection mobility control, radio admission control, measurement configuration/provision, dynamic resource allocation (scheduler), etc. The eNB 200 may be referred to as another terminology, such as a base station (BS), a base transceiver system (BTS), an access point (AP), etc. The eNB 200 may correspond to the base station 200 of FIG. 1, the second wireless device 200 of FIG. 2, or the wireless device 200 of FIG. 4.

A downlink (DL) denotes communication from the eNB 200 to the UE 100. An uplink (UL) denotes communication from the UE 100 to the eNB 200. A sidelink (SL) denotes communication between the UEs 100. In the DL, a transmitter may be a part of the eNB 200, and a receiver may be a part of the UE 100. In the UL, the transmitter may be a part of the UE 100, and the receiver may be a part of the eNB 200. In the SL, the transmitter and receiver may be a part of the UEs 100.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 300 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network. The MME/S-GW 300 may correspond to the network 300 of FIG. 1.

The UE 100 is connected to the eNB 200 by means of the Uu interface. The UEs 100 are interconnected with each other by means of the PC5 interface. The eNBs 200 are interconnected with each other by means of the X2 interface. The eNBs 200 are also connected by means of the S1 interface to the EPC, more specifically to the MME by means of the S1-MME interface and to the S-GW by means of the S1-U interface. The S1 interface supports a many-to-many relation between MMEs/S-GWs and eNBs.

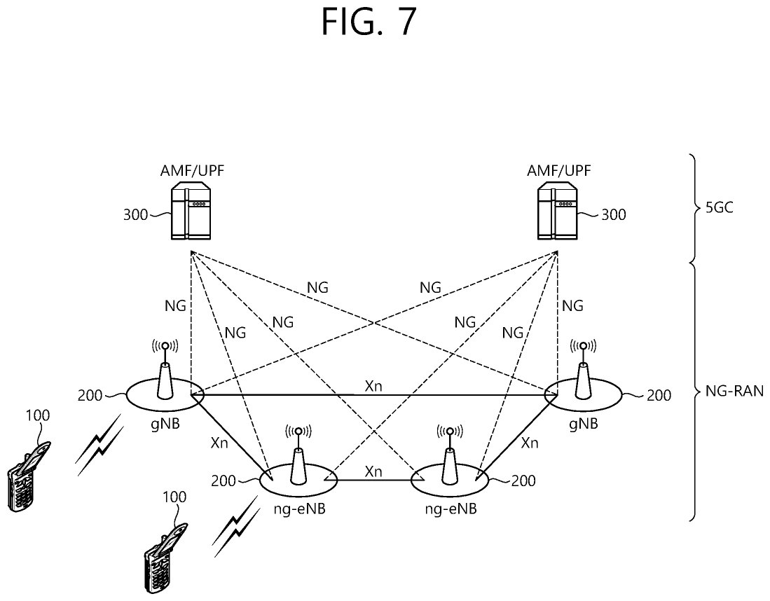

FIG. 7 shows another example of a wireless communication system to which the technical features of the present specification can be applied.

Specifically, FIG. 7 shows a system architecture based on a 5G NR. The entity used in the 5G NR (hereinafter, simply referred to as “NR”) may absorb some or all of the functions of the entities introduced in FIG. 6 (e.g., eNB, MME, S-GW). The entity used in the NR may be identified by the name “NG” for distinction from the LTE/LTE-A.

Referring to FIG. 7, the wireless communication system includes one or more UE 100, a next-generation RAN (NG-RAN) and a 5th generation core network (5GC). The NG-RAN consists of at least one NG-RAN node. The NG-RAN node is an entity corresponding to the eNB 200 shown in FIG. 6. The NG-RAN node consists of at least one gNB 200 and/or at least one ng-eNB 200. The gNB 200 provides NR user plane and control plane protocol terminations towards the UE 100. The ng-eNB 200 provides E-UTRA user plane and control plane protocol terminations towards the UE 100. The gNB 200 and/or ng-eNB 200 may correspond to the base station 200 of FIG. 1, the second wireless device 200 of FIG. 2, or the wireless device 200 of FIG. 4.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MME. The UPF hosts the functions, such as mobility anchoring, PDU handling. The UPF an entity including the functions of the conventional S-GW. The SMF hosts the functions, such as UE IP address allocation, PDU session control.

NR supports multiple numerology (or, subcarrier spacing (SCS)) to support various 5G services. For example, when the SCS is 15 kHz, wide area in traditional cellular bands may be supported. When the SCS is 30 kHz/60 kHz, dense-urban, lower latency and wider carrier bandwidth may be supported. When the SCS is 60 kHz or higher, a bandwidth greater than 24.25 GHz may be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency | Corresponding | Subcarrier |
|---|---|---|
| Range designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency | Corresponding | Subcarrier |
|---|---|---|
| Range designation | frequency range | Spacing |
| FR1 | 410 MHz-7125 MHz | 15, 30, 60 kHz |
| FR2 | 24250 MHz-52600 MHz | 60, 120, 240 kHz |

The gNBs 200 and ng-eNBs 200 are interconnected with each other by means of the Xn interface. The gNBs 200 and ng-eNBs 200 are also connected by means of the NG interfaces to the 5GC, more specifically to the AMF by means of the NG-C interface and to the UPF by means of the NG-U interface.

A protocol structure between network entities described above is described. On the system of FIG. 6 and/or FIG. 7, layers of a radio interface protocol between the UE and the network (e.g., NG-RAN and/or E-UTRAN) may be classified into a first layer (L1), a second layer (L2), and a third layer (L3) based on the lower three layers of the open system interconnection (OSI) model that is well-known in the communication system.

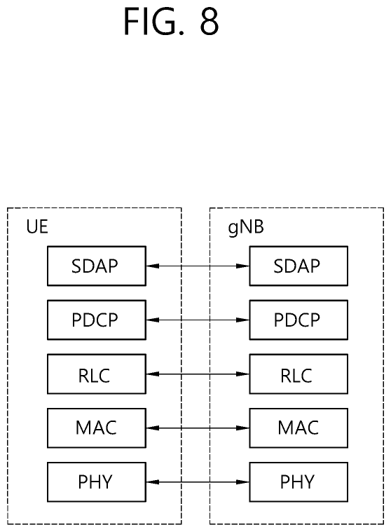

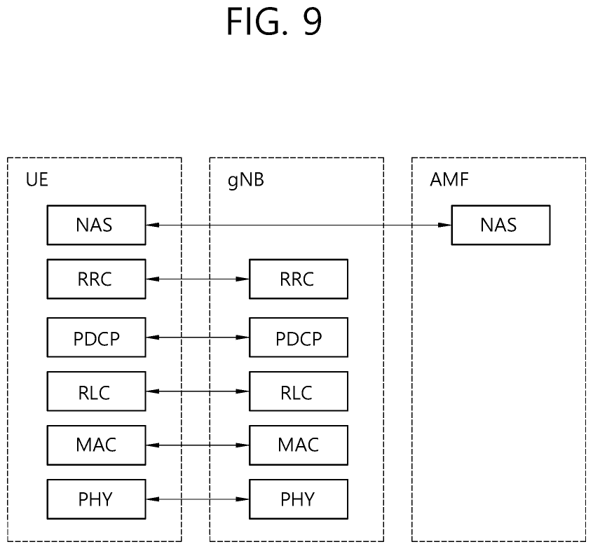

FIG. 8 shows a block diagram of a user plane protocol stack to which the technical features of the present specification can be applied. FIG. 9 shows a block diagram of a control plane protocol stack to which the technical features of the present specification can be applied.

The user/control plane protocol stacks shown in FIG. 8 and FIG. 9 are used in NR. However, user/control plane protocol stacks shown in FIG. 8 and FIG. 9 may be used in LTE/LTE-A without loss of generality, by replacing gNB/AMF with eNB/MME.

Referring to FIG. 8 and FIG. 9, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARQ), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e., transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the BS.

In RRC_CONNECTED, the UE has an RRC connection with the network (i.e., E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

Secondary Cell Group (SCG) reconfiguration is described. Section 5.3.10.10 of 3GPP TS 36.331 V15.2.2 (2018-06) can be referred.

The UE shall:

1> if makeBeforeBreakSCG is configured:

2> stop timer T313, if running;

2> start timer T307 with the timer value set to t307, as included in the mobilityControlInfoSCG;

2> start synchronizng to the DL of the target Primary Secondary Cell (PSCell), if needed;

2> perform the remainder of this procedure including and following resetting MAC after the UE has stopped the uplink transmission/downlink reception with the source SCG cell(s);

1> if the received scg-Configuration is set to release or includes the mobilityControlInfoSCG (i.e. SCG release/change):

2> if mobilityControlInfo is not received (i.e. SCG release/change without handover (HO)):

3> reset SCG MAC, if configured;

3> for each drb-Identity value that is part of the current UE configuration:

4> if the DRB indicated by drb-Identity is an SCG DRB:

5> re-establish the PDCP entity and the SCG RLC entity or entities;

4> if the DRB indicated by drb-Identity is a split DRB:

5> perform PDCP data recovery and re-establish the SCG RLC entity;

4> if the DRB indicated by drb-Identity is an Master Cell Group (MCG) DRB; and

4> drb-ToAddModListSCG is received and includes the drb-Identity value, while for this entry drb-Type is included and set to scg (i.e. MCG to SCG):

5> re-establish the PDCP entity and the MCG RLC entity or entities;

3> configure lower layers to consider the SCG SCell(s), except for the PSCell, to be in deactivated state;

1> if the received scg-Configuration is set to release:

2> release the entire SCG configuration, except for the DRB configuration (i.e. as configured by drb-ToAddModListSCG);

2> if the current UE configuration includes one or more split or SCG DRBs and the received RRCConnectionReconfiguration message includes radioResourceConfigDedicated including drb-ToAddModList:

3> reconfigure the SCG or split DRB by drb-ToAddModList;

2> stop timer T313, if running;

2> stop timer T307, if running;

1> else:

2> i the received scg-ConfigPartMCG includes the scg-Counter:

3> update the S-K_{eNB} key based on the K_{eNB} key and using the received scg-Counter value;

3> derive the K_{UPenc} key associated with the cipheringAlgorithmSCG included in mobilityControlInfoSCG within the received scg-ConfigPartSCG;

3> configure lower layers to apply the ciphering algorithm and the K_{UPenc} key;

2> if the received scg-ConfigPartSCG includes the radioResourceConfigDedicatedSCG:

3> reconfigure the dedicated radio resource configuration for the SCG;

2> if the current UE configuration includes one or more split or SCG DRBs and the received RRCConnectionReconfiguration message includes radioResourceConfigDedicated including drb-ToAddModList:

3> reconfigure the SCG or split DRB by drb-ToAddModList;

2> if the received scg-ConfigPartSCG includes the sCellToReleaseListSCG:

3> perform SCell release for the SCG;

2> if the received scg-ConfigPartSCG includes the pSCellToAddMod:

3> perform PSCell addition or modification;

This procedure is also used to release the PSCell e.g., PSCell change, System Information (SI) change for the PSCell.

2> if the received scg-ConfigPartSCG includes the sCellToAddModListSCG:

3> perform SCell addition or modification;

2> configure lower layers in accordance with mobilityControlInfoSCG, if received;

2> if rach-SkipSCG is configured:

3> configure lower layers to apply the rach-SkipSCG for the target SCG;

2> if the received scg-ConfigPartSCG includes the mobilityControlInfoSCG (i.e., SCG change):

3> resume all SCG DRBs and resume SCG transmission for split DRBs, if suspended;

3> stop timer T313, if running;

3> start timer T307 with the timer value set to t307, as included in the mobilityControlInfoSCG, if makeBeforeBreakSCG is not configured;

3> start synchronising to the DL of the target PSCell;

3> initiate the random access procedure on the PSCell, if rach-SkipSCG is not configured:

The UE is not required to determine the System Frame Number (SFN) of the target PSCell by acquiring system information from that cell before performing RACH access in the target PSCell.

3> the procedure ends, except that the following actions are performed when MAC successfully completes the random access procedure on the PSCell or when MAC indicates the successful reception of a PDCCH transmission addressed to C-RNTI and if rach-skipSCG is configured:

4> stop timer T307;

4> release rach-SkipSCG;

4> apply the parts of the Channel Quality Indicator (CQI) reporting configuration, the scheduling request configuration and the sounding RS configuration that do not require the UE to know the SFN of the target PSCell, if any;

4> apply the parts of the measurement and the radio resource configuration that require the UE to know the SFN of the target PSCell (e.g., periodic CQI reporting, scheduling request configuration, sounding RS configuration), if any, upon acquiring the SFN of the target PSCell;

The UE shall:

1> if T307 expires (i.e., SCG change failure):

Following T307 expiry any dedicated preamble, if provided within the rach-ConfigDedicatedSCG, is not available for use by the UE anymore.

2> initiate the SCG failure information procedure to report SCG change failure.

SCG failure information is described. Section 5.6.13 of 3GPP TS 36.331 V15.2.2 (2018-06) can be referred. The purpose of this procedure is to inform E-UTRAN about an SCG failure the UE has experienced i.e., SCG radio link failure, SCG change failure.

A UE initiates the procedure to report SCG failures when SCG transmission is not suspended and when one of the following conditions is met:

1> upon detecting radio link failure for the SCG; or

1> upon SCG change failure; or

1> upon stopping uplink transmission towards the PSCell due to exceeding the maximum uplink transmission timing difference when powerControlMode is configured to 1.

In case of Dual Connectivity (DC), upon initiating the procedure, the UE shall:

1> suspend all SCG DRBs and suspend SCG transmission for split DRBs;

1> reset SCG-MAC;

1> stop T307;

1> initiate transmission of the SCGFailureInformation message;

The UE shall set the contents of the SCGFailureInformation message as follows:

1> if the UE initiates transmission of the SCGFailureInformation message to provide SCG radio link failure information:

2> include failureType and set it to the trigger for detecting SCG radio link failure;

1> else if the UE initiates transmission of the SCGFailureInformation message to provide SCG change failure information:

2> include failureType and set it to scg-ChangeFailure;

1> else if the UE initiates transmission of the SCGFailureInformation message due to exceeding maximum uplink transmission timing difference:

2> include failureType and set it to maxUL-TimingDiff;

1> set the measResultServFreqList to include for each E-UTRA SCG cell that is configured, if any, within measResultSCell the quantities of the concerned SCell, if available;

1> for each E-UTRA SCG serving frequency included in measResultServFreqList, include within measResultBestNeighCell the physCellId and the quantities of the best non-serving cell, based on Reference Signal Received Power (RSRP), on the concerned serving frequency;

1> set the measResultNeighCells to include the best measured cells on non-serving E-UTRA frequencies, ordered such that the best cell is listed first, and based on measurements collected up to the moment the UE detected the failure, and set its fields as follows;

2> if the UE was configured to perform measurements for one or more non-serving EUTRA frequencies and measurement results are available, include the measResultListEUTRA;

2> for each neighbor cell included, include the optional fields that are available;

The measured quantities are filtered by the L3 filter as configured in the mobility measurement configuration. The measurements are based on the time domain measurement resource restriction, if configured. Blacklisted cells are not required to be reported.

The UE shall submit the SCGFailureInformation message to lower layers for transmission.

Measurements general is described. Section 5.5.1 of 3GPP TS 38.331 V15.2.0 (2018-06) can be referred.

The network may configure an RRC_CONNECTED UE to perform measurements and report them in accordance with the measurement configuration. The measurement configuration is provided by means of dedicated signaling i.e. using the RRCReconfiguration.

The network may configure the UE to perform the following types of measurements.
NR measurements;
Inter-RAT measurements of E-UTRA frequencies.

The network may configure the UE to report the following measurement information based on SS/Physical Broadcast Channel (PBCH) block(s).
Measurement results per SS/PBCH block;
Measurement results per cell based on SS/PBCH block(s);
SS/PBCH block(s) indexes.

The network may configure the UE to report the following measurement information based on Channel State Information Reference Signal (CSI-RS) resources.
Measurement results per CSI-RS resource;
Measurement results per cell based on CSI-RS resource(s);
CSI-RS resource measurement identifiers.

The measurement configuration includes the following parameters.

(1) Measurement objects (MOs): A list of objects on which the UE shall perform the measurements.
For intra-frequency and inter-frequency measurements a measurement object indicates the frequency/time location and subcarrier spacing of reference signals to be measured. Associated with this measurement object, the network may configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.
The measObjectId of the MO which corresponds to each serving cell is indicated by servingCellMO within the serving cell configuration.
For inter-RAT E-UTRA measurements, a measurement object is a single EUTRA carrier frequency. Associated with this E-UTRA carrier frequency, the network can configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.

(2) Reporting configurations: A list of reporting configurations where there can be one or multiple reporting configurations per measurement object. Each reporting configuration consists of the following.
Reporting criterion: The criterion that triggers the UE to send a measurement report.

This can either be periodical or a single event description.
Reference signal (RS) type: The RS that the UE uses for beam and cell measurement results (SS/PBCH block or CSI-RS).
Reporting format: The quantities per cell and per beam that the UE includes in the measurement report (e.g., Reference Signal Received Power (RSRP)) and other associated information such as the maximum number of cells and the maximum number beams per cell to report.

(3) Measurement identities: A list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network.

(4) Quantity configurations: The quantity configuration defines the measurement filtering configuration used for all event evaluation and related reporting of that measurement type. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.

(5) Measurement gaps: Periods that the UE may use to perform measurements, i.e. no (UL, DL) transmissions are scheduled.

A UE in RRC_CONNECTED maintains a measurement object list, a reporting configuration list, and a measurement identities list according to signaling and procedures. The measurement object list possibly includes NR intra-frequency object(s), NR inter-frequency object(s) and inter-RAT objects. Similarly, the reporting configuration list includes NR and inter-RAT reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells.

(1) The NR serving cell(s)—these are the SpCell and one or more SCells.

(2) Listed cells—these are cells listed within the measurement object(s).

(3) Detected cells—these are cells that are not listed within the measurement object(s) but are detected by the UE on the SS/PBCH block frequency(ies) and subcarrier spacing(s) indicated by the measurement object(s).

For NR measurement object(s), the UE measures and reports on the serving cell(s), listed cells and/or detected cells.

Measurement reporting triggering is described. Section 5.5.4 of 3GPP TS 38.331 V15.2.0 (2018-06) can be referred.

If security has been activated successfully, the UE shall:

1> for each measId included in the measIdList within VarMeasConfig:

2> if the corresponding reportConfigincludes a reportType set to eventTriggered or periodical;

3> if the corresponding measObject concerns NR;

4> if the eventA1 or eventA2 is configured in the corresponding reportConfig:

5> consider only the serving cell to be applicable;

4> else:

5> for events involving a serving cell associated with a measObjectNR and neighbours associated with another measObjectNR, consider any serving cell associated with the other measObjectNR to be a neighbouring cell as well;

5> if useWhiteCellList is set to TRUE:

6> consider any neighbouring cell detected based on parameters in the associated measObjectNR to be applicable when the concerned cell is included in the whiteCellsToAddModList defined within the VarMeasConfig for this measId;

5> else:

6> consider any neighbouring cell detected based on parameters in the associated measObjectNR to be applicable when the concerned cell is not included in the blackCellsToAddModList defined within the VarMeasConfig for this measId;

2> if the reportType is set to eventTriggered and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):

3> include a measurement reporting entry within the VarMeasReportList for this measId;

3> set the numberOfReportsSent defined within the VarMeasReportList for this measId to 0;

3> include the concerned cell(s) in the cellsTriggeredList defined within the VarMeasReportList for this measId;

3> initiate the measurement reporting procedure;

2> if the reportType is set to eventTriggered and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):

3> set the numberOfReportsSent defined within the VarMeasReportList for this measId to 0;

3> include the concerned cell(s) in the cellsTriggeredList defined within the VarMeasReportList for this measId;

3> initiate the measurement reporting procedure;

2> if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:

3> remove the concerned cell(s) in the cellsTriggeredList defined within the VarMeasReportList for this measId;

3> if reportOnLeave is set to TRUE for the corresponding reporting configuration:

4> initiate the measurement reporting procedure;

3> if the cellsTriggeredList defined within the VarMeasReportList for this measId is empty:

4> remove the measurement reporting entry within the VarMeasReportList for this measId;

4> stop the periodical reporting timer for this measId, if running;

2> if reportType is set to periodical and if a (first) measurement result is available:

3> include a measurement reporting entry within the VarMeasReportList for this measId;

3> set the numberOfReportsSent defined within the VarMeasReportList for this measId to 0;

4> if the reportAmount exceeds 1:

5> initiate the measurement reporting procedure, immediately after the quantity to be reported becomes available for the NR SpCell;

4> else (i.e. the reportAmount is equal to 1):

5> initiate the measurement reporting procedure, immediately after the quantity to be reported becomes available for the NR SpCell and for the strongest cell among the applicable cells;

2> upon expiry of the periodical reporting timer for this measId:

3> initiate the measurement reporting procedure.

Event A1 is an event that serving cell quality becomes better than threshold. The UE shall:

1> consider the entering condition for this event to be satisfied when condition A1-1, as specified below, is fulfilled;

1> consider the leaving condition for this event to be satisfied when condition A1-2, as specified below, is fulfilled;

1> for this measurement, consider the NR serving cell corresponding to the associated measObjectNR associated with this event.

[Inequality A1-1] (Entering Condition)

Ms−Hys>Thresh

[Inequality A1-2] (Leaving Condition)

Ms+Hys<Thresh

In the above inequalities, Ms is the measurement result of the serving cell, not taking into account any offsets. Hys is the hysteresis parameter for this event (i.e. hysteresis as defined within reportConfigNR for this event). Thresh is the threshold parameter for this event (i.e. a1-Threshold as defined within reportConfigNR for this event).

Event A2 is an event that serving cell quality becomes worse than threshold. The UE shall:

1> consider the entering condition for this event to be satisfied when condition A2-1, as specified below, is fulfilled;

1> consider the leaving condition for this event to be satisfied when condition A2-2, as specified below, is fulfilled;

1> for this measurement, consider the serving cell indicated by the measObjectNR associated to this event.

[Inequality A2-1] (Entering Condition)

Ms+Hys<Thresh

[Inequality A2-2] (Leaving Condition)

Ms−Hys>Thresh

In the above inequalities, Ms is the measurement result of the serving cell, not taking into account any offsets. Hys is the hysteresis parameter for this event (i.e. hysteresis as defined within reportConfigNR for this event). Thresh is the threshold parameter for this event (i.e. a2-Threshold as defined within reportConfigNR for this event).

Event A3 is an event that neighbour cell quality becomes offset better than SpCell quality. The UE shall:

1> consider the entering condition for this event to be satisfied when condition A3-1, as specified below, is fulfilled;

1> consider the leaving condition for this event to be satisfied when condition A3-2, as specified below, is fulfilled;

1> use the PSCell for Mp, Ofp and Ocp.

The cell(s) that triggers the event has reference signals indicated in the measObjectNR associated to this event which may be different from the NR SpCell measObjectNR.

[Inequality A3-1] (Entering Condition)

Mn+Ofn+Ocn−Hys>Mp+Ofp+Ocp+Off

[Inequality A3-2] (Leaving Condition)

Mn+Ofn+Ocn+Hys<Mp+Ofp+Ocp+Off

In the above inequalities, Mn is the measurement result of the neighbouring cell, not taking into account any offsets. Ofn is the measurement object specific offset of the reference signal of the neighbour cell (i.e. offsetMO as defined within measObjectNR corresponding to the neighbour cell). Ocn is the cell specific offset of the neighbour cell (i.e. cellIndividualOffset as defined within measObjectNR corresponding to the frequency of the neighbour cell), and set to zero if not configured for the neighbour cell. Mp is the measurement result of the SpCell, not taking into account any offsets. Ofp is the measurement object specific offset of the SpCell (i.e. offsetMO as defined within measObjectNR corresponding to the SpCell). Ocp is the cell specific offset of the SpCell (i.e. celllndividualOffset as defined within measObjectNR corresponding to the SpCell), and is set to zero if not configured for the SpCell. Hys is the hysteresis parameter for this event (i.e. hysteresis as defined within reportConfigNR for this event). Off is the offset parameter for this event (i.e. a3-Offset as defined within reportConfigNR for this event).

Event A4 is an event that neighbour cell quality becomes better than threshold. The UE shall:

1> consider the entering condition for this event to be satisfied when condition A4-1, as specified below, is fulfilled;

1> consider the leaving condition for this event to be satisfied when condition A4-2, as specified below, is fulfilled.

[Inequality A4-1] (Entering Condition)

Mn+Ofn+Ocn−Hys>Thresh

[Inequality A4-2] (Leaving Condition)

Mn+Ofn+Ocn+Hys<Thresh

In the above inequalities, Mn is the measurement result of the neighbouring cell, not taking into account any offsets. Ofn is the measurement object specific offset of the neighbour cell (i.e. offsetMO as defined within measObjectNR corresponding to the neighbour cell). Ocn is the measurement object specific offset of the neighbour cell (i.e. celllndividualOffset as defined within measObjectNR corresponding to the neighbour cell), and set to zero if not configured for the neighbour cell. Hys is the hysteresis parameter for this event (i.e. hysteresis as defined within reportConfigNR for this event). Thresh is the threshold parameter for this event (i.e. a4-Threshold as defined within reportConfigNR for this event).

Event A5 is an event that SpCell quality becomes worse than threshold1 and neighbour cell quality becomes better than threshold2. The UE shall:

1> consider the entering condition for this event to be satisfied when both condition A5-1 and condition A5-2, as specified below, are fulfilled;

1> consider the leaving condition for this event to be satisfied when condition A5-3 or condition A5-4, i.e. at least one of the two, as specified below, is fulfilled;

1> use the PSCell for Mp.

The parameters of the reference signal(s) of the cell(s) that triggers the event are indicated in the measObjectNR associated to the event which may be different from the measObjectNR of the NR SpCell.

[Inequality A5-1] (Entering Condition 1)

Mp+Hys<Thresh1

[Inequality A5-2] (Entering Condition 2)

Mn+Ofn+Ocn−Hys>Thresh2

[Inequality A5-3] (Leaving Condition 1)

Mp−Hys>Thresh1

[Inequality A5-4] (Leaving Condition 2)

Mn+Ofn+Ocn+Hys<Thresh2

In the above inequalities, Mp is the measurement result of the NR SpCell, not taking into account any offsets. Mn is the measurement result of the neighbouring cell, not taking into account any offsets. Ofn is the measurement object specific offset of the neighbour cell (i.e. offsetMO as defined within measObjectNR corresponding to the neighbour cell). Ocn is the cell specific offset of the neighbour cell (i.e. celllndividualOffset as defined within measObjectNR corresponding to the neighbour cell), and set to zero if not configured for the neighbour cell. Hys is the hysteresis parameter for this event (i.e. hysteresis as defined within reportConfigNR for this event). Thresh1 is the threshold parameter for this event (i.e. a5-Threshold1 as defined within reportConfigNR for this event). Thresh2 is the threshold parameter for this event (i.e. a5-Threshold2 as defined within reportConfigNR for this event).

Event A6 is an event that neighbour cell quality becomes offset better than SCell quality. The UE shall:

1> consider the entering condition for this event to be satisfied when condition A6-1, as specified below, is fulfilled;

1> consider the leaving condition for this event to be satisfied when condition A6-2, as specified below, is fulfilled;

1> for this measurement, consider the (secondary) cell corresponding to the measObjectNR associated to this event to be the serving cell.

The reference signal(s) of the neighbour(s) and the reference signal(s) of the SCell are both indicated in the associated measObjectNR.

[Inequality A6-1] (Entering Condition)

Mn+Ocn−Hys>Ms+Ocs+Off

[Inequality A6-2] (Leaving Condition)

Mn+Ocn+Hys<Ms+Ocs+Off

In the above inequalities, Mn is the measurement result of the neighbouring cell, not taking into account any offsets. Ocn is the cell specific offset of the neighbour cell (i.e. celllndividualOffset as defined within the associated measObjectNR), and set to zero if not configured for the neighbour cell. Ms is the measurement result of the serving cell, not taking into account any offsets. Ocs is the cell specific offset of the serving cell (i.e. celllndividualOffset as defined within the associated measObjectNR), and is set to zero if not configured for the serving cell. Hys is the hysteresis parameter for this event (i.e. hysteresis as defined within reportConfigNR for this event). Off is the offset parameter for this event (i.e. a6-Offset as defined within reportConfigNR for this event).

Non-Terrestrial Network (NTN) is described. 3GPP RP-181370 and 3GPP TR 38.821 V0.1.0 (2018-09) can be referred. NTN refer to networks, or segments of networks, using an airborne or spaceborne vehicle for transmission.

Spaceborne vehicles may include satellites (including Low Earth Orbiting (LEO) satellites, Medium Earth Orbiting (MEO) satellites, Geostationary Earth Orbiting (GEO) satellites as well as Highly Elliptical Orbiting (HEO) satellites). LEO satellites orbit around the Earth with an altitude between 300 km, and 1500 km. MEO satellites orbit around the Earth above LEO and below geostationary Earth Orbit. GEO satellites orbit at 35,786 km above the Earth's equator and following the direction of the Earth's rotation. An object in such an orbit has an orbital period equal to the Earth's rotational period and thus appears motionless, at a fixed position in the sky, to ground observers.

Airborne vehicles may include High Altitude Platforms (HAPs) encompassing Unmanned Aircraft Systems (UAS) including Lighter than Air UAS (LTA), Heavier than Air UAS (HTA), all operating in altitudes typically between 8 and 50 km, quasi-stationary.

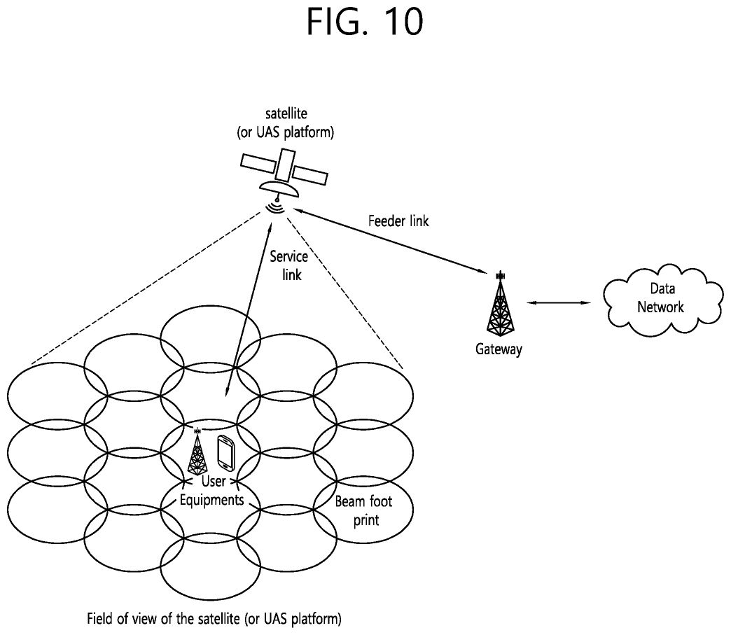

FIG. 10 shows an example of NTN typical scenario to which the technical features of the present specification can be applied.

Referring to FIG. 10, NTN typically features the following elements.

(1) One or several sat-gateways that connect the NTN to a public data network
A GEO satellite is fed by one or several sat-gateways which are deployed across the satellite targeted coverage (e.g. regional or even continental coverage). It may be assumed that UE in a cell are served by only one sat-gateway.
A Non-GEO satellite served successively by one sat-gateway at a time: The system ensures service and feeder link continuity between the successive serving sat-gateways with sufficient time duration to proceed with mobility anchoring and handover.

(2) A Feeder link or radio link between a sat-gateway and the satellite (or UAS platform)

(3) A service link or radio link between the UE and the satellite (or UAS platform)

(4) A satellite (or UAS platform) which may implement either a transparent or a regenerative (with on board processing) payload: The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
A transparent payload: Radio frequency filtering, frequency conversion and amplification. Hence, the waveform signal repeated by the payload is un-changed.
A regenerative payload: Radio frequency filtering, frequency conversion and amplification as well as demodulation/decoding, switch and/or routing, coding/modulation. This is effectively equivalent to having all or part of base station functions (e.g. gNB) on board the satellite (or UAS platform).

(5) Inter-satellite links (ISL) optionally in case of a constellation of satellites. This will require regenerative payloads on board the satellites. ISL may operate in RF frequency or optical bands.

(6) UEs are served by the satellite (or UAS platform) within the targeted service area.

Table 3 shows an example of different types of satellites (or UAS platforms).

TABLE 3

| | | | | Typical beam | |
|---|---|---|---|---|---|
| Platforms | Altitude range | | Orbit | footprint size | |
| LEO satellite | 300-1500 | km | Circular around the | 100-500 | km |
| MEO satellite | 7000-25000 | km | earth | 100-500 | km |
| GEO satellite | 35,786 | km | notional station | 200-1000 | km |
| UAS platform | 8-50 | km | keeping position | 5-200 | km |
| (including HAPS) | (20 km for | | fixed in terms of | | |
| | HAPS) | | elevation/azimuth | | |
| | | | with respect to a | | |
| | | | given earth point | | |
| HEO satellite | 400-50000 | km | Elliptical around the | 200-1000 | km |
| | | | earth | | |

Typically, GEO satellite and UAS are used to provide continental, regional or local service. A constellation of LEO and MEO is used to provide services in both Northern and Southern hemispheres. In some case, the constellation can even provide global coverage including polar regions. For the later, this requires appropriate orbit inclination, sufficient beams generated and inter-satellite links.

Table 4 shows propagation delays for GEO satellite at 35786 km.

TABLE 4

| | GEO at 35786 km | | |
|---|---|---|---|
| Elevation angle | Path | D (km) | Time (ms) |
| UE: 10° | satellite-UE | 40586 | 135.286 |
| GW: 5° | satellite-gateway | 41126.6 | 137.088 |
| 90° | satellite-UE | 35786 | 119.286 |

Bent Pipe satellite

| | | | |
|---|---|---|---|
| One way delay | Gateway-satellite_UE | 81712.6 | 272.375 |
| Round trip Time | Twice | 163425.3 | 544.751 |

Regenerative Satellite

| | | | |
|---|---|---|---|
| One way delay | Satellite - UE | 40586 | 135.286 |
| Round Trip | Satellite-UE-Satellite | 81172 | 270.572 |
| Time | | | |

There may be several issues that need to be addressed for NTN. As one of the several issues, propagation delay may be considered. Naturally, the satellite systems may feature much larger propagation delays than terrestrial systems. As mentioned in Table 4 above, the one-way delay between the UE and the RAN (whether on-board the satellite/HAPS or on the ground) may reach up to 272.385 ms for GEO satellite. Even though not mentioned in Table 4 above, the one-way delay between the UE and the RAN (whether on-board the satellite/HAPS or on the ground) may be greater than 14.2 ms for non-GEO satellite. It means that round trip time (RTT) between the UE and the gNB (satellite) could be over 540 ms for GEO satellite as the worst scenario. This is significant issue to consider, given that the maximum propagation delay allowed for terrestrial systems is 10 ms (in case of 5G, <1 ms).

The propagation delay mentioned above may cause providing invalid configuration if the network applies user's input, such as measurement reporting, UE (assistant) information, etc., to the RRC (Re-) configuration. The most important scenario is mobility. The network supports the mobility (e.g., SCG change) based on the measurement report transmitted from the UE. Because, in NTN, UE with maximum 1000 km velocity is considered including aerial service, radio quality can be drifty deviated especially in the case of moving Line-of-Sight (LOS) area to Non-LOS (NLOS) area or vice versa. In this kind of scenarios, even though the network provides a CG change command upon receiving the measurement report from the UE based on e.g., entering event A3 mentioned above, the cell which was satisfied with the entering event A3 may leave the event A3 when the CG change command is received by the UE.

Following cases could be possible to become invalid CG change command to the UE.

(1) Upon Measurement Reporting, Serving Cell Quality Becomes Good

In this case, the UE may perform measurement reporting based on e.g., entering event A3, and the network may provide RRC Reconfiguration including CG change command after over 500 ms. During the delay time of over 500 ms, the serving cell quality may become good so that leaving condition of the event is satisfied.

(2) Upon Measurement Reporting, Target Cell Quality Becomes Bad

In this case, the UE may perform measurement reporting based on e.g., entering event A3, and the network may provide RRC Reconfiguration including CG change command after over 500 ms. During the delay time of over 500 ms, the target cell quality may become bad so that leaving condition of the event is satisfied.

(3) Upon Measurement Reporting, Another Cell Becomes Good

In this case, the UE may perform measurement reporting based on e.g., entering event A3, and the network may provide RRC Reconfiguration including CG change command after over 500 ms. During the delay time of 500 ms, the UE may detect another cell which is better than the target cell to move.

The above mentioned scenarios may come together. Especially, in case (2) above, considering that the target cell is going worse, the CG change may fail with higher possibility than terrestrial cases.

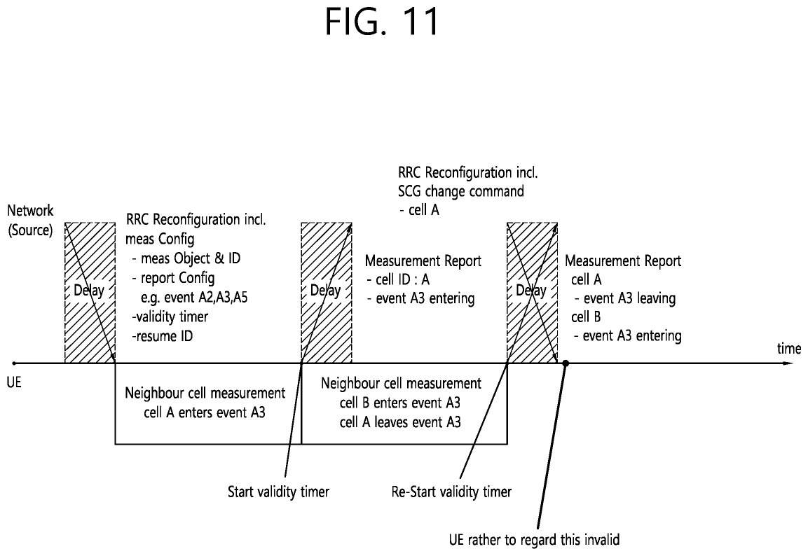

FIG. 11 shows an example of propagation delay problem in NTN.

Referring to FIG. 11, the interaction between the network (i.e., serving cell) and the UE is as follows.
The UE receives a RRC Reconfiguration message including a measurement configuration. The measurement configuration includes configuration of measurement objects and measurement identities. The measurement configuration includes a measurement reporting configurations regarding e.g., event A2, A3 and/or A5. The measurement configuration may further include information on validity timer and resume ID. There may be delay, e.g., up to 270 ms, between transmission by the network and reception by the UE.
The UE performs neighbor cell measurements. As a result of neighbor cell measurement, it is determined that neighbor cell A satisfies entering condition of event A3. The UE performs measurement reporting to the network (i.e., measurement reporting #1). The measurement reporting includes information that the neighbor cell A enters event A3. There may be delay, e.g., up to 270 ms, between transmission by the UE and reception by the network. Upon performing measurement reporting #1, validity timer may start.
In the meantime before receiving a CG change command from the network, the UE continuously performs neighbor cell measurements. As a result of neighbor cell measurement, it is determined that the neighbor cell A satisfies leaving condition of event A3, and instead neighbor cell B satisfies entering condition of event A3. The UE performs measurement reporting to the network (i.e., measurement reporting #2). The measurement reporting includes information that the neighbor cell A leaves event A3 and the neighbor cell B enters event A3. There may be delay, e.g., up to 270 ms, between transmission by the UE and reception by the network. Upon performing measurement reporting #2, validity timer may re-start.
Before receiving the measurement reporting #2 from the UE, the network may transmit a RRC Reconfiguration message including a CG change command which commands CG change for the neighbor cell A based on the measurement reporting #1. However, upon receiving the CG change command which commands CG change for the neighbor cell A, because the neighbor cell A already leaves event A3 (i.e., quality of the neighbor cell A becomes worse), the UE may regard the CG change command as invalid.

In other words, mobility support for UEs in NTN needs to be considered. As mentioned above, improper mobility command may be provided due to cell measurement state change caused by propagation delay. Therefore, there may be a problem that can cause unnecessary data service delays due to mobility failure.

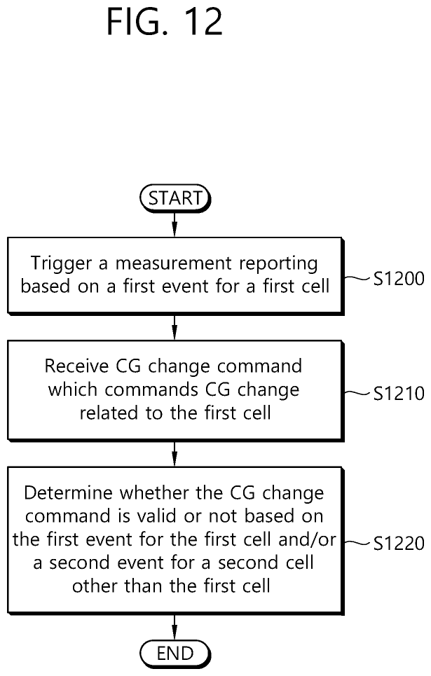

FIG. 12 shows an example of a method for performing delayed CG change procedure according to an embodiment of the present specification.

The wireless device may be in communication with at least one of a mobile device, a network, and/or autonomous vehicles other than the wireless device.

In step S1200, the wireless device triggers a measurement reporting based on a first event for a first cell.

In some implementations of the present specification, when the wireless device is in RRC_CONNCECTED, the wireless device may receive a measurement configuration. The measurement configuration may be received via an RRC (re-) configuration message. The measurement configuration may intend to be used for the CG change. That is, upon receiving the measurement report which was obtained from neighbor cell measurement based on the measurement configuration from the wireless device, the network may apply/initiate the CG change based on the received measurement report.

In some implementations of the present specification, the measurement configuration may include information on the first event for the first cell. Furthermore, the measurement configuration may include information on a second event for a second cell other than the second cell. The first cell may be a target cell of the CG change. The second cell may be another neighbor cell other than the target cell of the CG change. The first event and/or the second event may be any one of event A1, A2, A3, A4, A5 and/or A6. The measurement configuration may optionally include information on a new validity timer. The new validity timer may be used to detect invalid (i.e., not proper) configuration due to signaling delay.

In some implementations of the present specification, the network may optionally provide resume identity to reduce data latency when the configuration becomes invalid.

In some implementations of the present specification, upon receiving the measurement configuration, the wireless device may perform neighbor cell measurement based on the measurement configuration and trigger the measurement reporting. The measurement reporting may include information for a cell for which an event triggering condition is considered to be satisfied based on results of the neighbor cell measurement. If the information on the new validity timer is provided to the wireless device, whenever the measurement report is transmitted, the new validity timer may start.

In step S1210, the wireless device receives a CG change command which commands a CG change related to the first cell. The CG change command may be received via an RRC (re-)configuration message from the network.

In step S1220, the wireless device determines whether the CG change command is valid or not based on the first event for the first cell and/or a second event for a second cell other than the first cell.

In some implementations of the present specification, the received CG change command may be considered not to be valid (i.e., not proper) configuration when at least one of the following conditions are met. The following conditions may be related to measurement status change.
If the wireless device has already reported another cell (e.g., second cell) for which another event triggering condition (e.g., the second event) is satisfied based on the updated measurement results and the wireless device considers the another cell is better to move than the target cell (e.g., the first cell) of the CG change, and/or
If the wireless device is about to report another cell (e.g., second cell) for which another event triggering condition is satisfied based on the updated measurement results and the wireless device considers the another cell is better to move than the target cell (e.g., the first cell) of the CG change, and/or
If the wireless device has already reported that a leaving condition for the triggered event (e.g., the first event) for the target cell (e.g., the first cell) of the CG change is now satisfied, and/or
If the wireless device is about to report that a leaving condition for the triggered event (e.g., the first event) for the target cell (e.g., the first cell) of the CG change is now satisfied, and/or
If the new validity timer is still ruing and at least one of the above conditions is met.

In other words, it may be determined that the CG change command is not valid based on a leaving condition for the first event being satisfied for the first cell. Alternatively and/or additionally, it may be determined that the CG change command is not valid based on an entering condition for the second event being satisfied for the second cell and consideration that the second cell is better to move than the first cell. Alternatively and/or additionally, it may be determined that the CG change command is not valid based on a validity timer being running.

In some implementations of the present specification, upon considering the received CG change command as invalid, the wireless device may perform at least one of the following operations.

(1) The wireless device may declare RLF based on a determination that the CG change command is not valid. The wireless device may perform a (RRC) re-establishment procedure or a (RRC) resume procedure after declaring the RLF.

In some implementations of the present specification, if the wireless device has received the resume identity from the network, the wireless device may be able to perform RRC resume procedure. Otherwise, the wireless device may perform RRC re-establishment procedure.

In some implementations of the present specification, during performing the RRC re-establishment procedure or RRC resume procedure, the wireless device may not perform cell search and may directly access to another cell which is measured after the first measurement reporting. For example, if another cell (e.g., second cell) for which another event triggering condition (e.g., the second event) is satisfied based on the updated measurement results and the wireless device considers the another cell is better to move than the target cell (e.g., the first cell) of CG change, the wireless device may directly access to another cell without performing cell search.

(2) Instead of complying the CG change command, the wireless device may reject the CG change command based on a determination that the CG change command is not valid, and the CG change related to the first cell may not be performed. The wireless device may transmit information informing that the CG change related to the first cell is not performed to a network. The information may be used to inform that the received CG change command is invalid. The information may be transmitted via an RRC (re-)configuration complete message or CG failure information.

(3) The wireless device may perform the CG change related to the first cell based on the CG change command, and transmit information informing that the first cell is no more proper to connect. That is, the wireless device may perform the CG change related to the first cell regardless of invalidity of the CG change command. The information may be used to inform that the received CG change command is invalid. The information may be transmitted via an RRC (re-)configuration complete message to the target cell.

In above description, the CG change may include SCG change in which SCG is added/modified/released while current MCG is maintained. Furthermore, the CG change may include MCG change in which MCG is added/modified/released while current SCG is maintained. In the description below, the SCG change is exemplarily described for the sake of convenience, but the present specification may not be limited thereto.

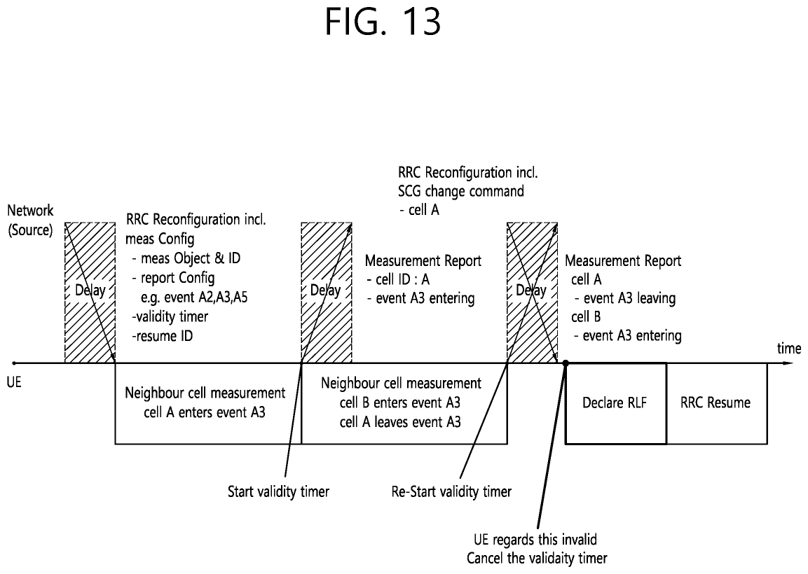

FIG. 13 shows an example of a method for performing delayed SCG change procedure according to an embodiment of the present specification.

In some implementations of the present specification, the wireless device is connecting to a network, serving cell e.g., gNB, eNB.

In some implementations of the present specification, the serving cell decides that the wireless device needs to prepare SCG change procedure because signaling quality between the serving cell (e.g., PSCell) and the wireless device is getting worse. The serving cell may provide measurement configuration to receive measurement report from the wireless device. Considering propagation delay between the serving cell and the wireless device, the serving cell may also provide a new validity timer and resume identity optionally.

In some implementations of the present specification, the wireless device receives RRC message, e.g., RRC Reconfiguration message, including the measurement configuration from the serving cell. To decide the most proper cell to SCG change, the serving cell may configure the wireless device in the measurement configuration with one more event condition for the given carrier frequency, e.g., event A3.

In some implementations of the present specification, upon receiving the measurement configuration, the wireless device may perform neighbor cell measurement based on the measurement configuration. The wireless device may confirm that cell A is satisfied with the entering condition of event A3 during the timer-to-trigger defined for the event A3. The wireless device may decide the cell A to report entering event A3. The wireless device may transmit measurement report message including that the cell A enters event A3 to the serving cell. The wireless device may start the new validity timer if available.

In some implementations of the present specification, the serving cell receives measurement report message for the cell A from the wireless device, and prepare SCG change procedure from the serving cell to the cell A. For this, SCG change request and confirm may be exchanged between the serving cell and the cell A.

In some implementations of the present specification, while the network prepares SCG change procedure, the wireless device may keep performing neighbor cell measurement based on the measurement configuration. Then, the wireless device may confirm that the cell A is satisfied with the leaving condition of event A3 during the timer-to-trigger defined for the event A3. The wireless device may decide the cell A to report leaving event A3. Also, the wireless device may confirm that the cell B is now satisfied with the entering condition of event A3 during the timer-to-trigger defined for the event A3. The UE may decide the cell B to report entering event A3. The wireless device may transmit measurement report message including that the cell A leaves event A3 and the cell B enters event A3 to the source cell. The wireless device may re-start the new validity timer if available.

In some implementations of the present specification, after SCG change preparation, the serving cell transmits a SCG change command which commands SCG change related to the cell A, before receiving the updated measurement report message including that the cell A leaves event A3 (i.e., the cell A is no more proper cell to connect for the SCG change) from the wireless device due to propagation delay. The SCG change command may be transmitted via RRC message e.g., RRC reconfiguration message.

In some implementations of the present specification, upon receiving the SCG change command via the RRC message e.g., RRC reconfiguration message, the wireless device may regard the SCG change command invalid because the new validity timer is still running which means that the received RRC message is not considered the latest measurement report. The wireless device may cancel the new validity timer. The wireless device may perform at least one of the following procedures.

(1) Declaring RLF

The wireless device may declare RLF and search a new cell to access. If the wireless device receives resume identity previously, the RRC resume procedure may be performed. For the cell search procedure, the UE may be able to try to access to the cell B without additional neighbor cell measurement procedure because the cell B is satisfied with entering condition of event A3.

(2) Rejection of the SCG Change Command

The wireless device may not comply the RRC message including the SCG change command. The wireless device may send RRC message, e.g., RRC reconfiguration complete message or SCG failure information, to the serving cell to indicate that the wireless device does not perform the SCG change related to the cell A. The wireless device may set new information to indicate invalid SCG change in the RRC message. In case of triggering transmission of SCG failure information to inform of invalid SCG Change, the wireless device may send SCG failure information after/instead of sending RRC Reconfiguration Complete message.

(3) Indication after SCG Change

The wireless device may perform SCG change related to the cell A and after SCG change completion, the wireless device send RRC message, e.g., RRC reconfiguration complete message, to the cell A to indicate that the cell A is no more proper to connect. The wireless device may set new information to indicate invalid SCG change in the RRC message.

The present specification may be applied to various future technologies, such as AI.

<AI>

AI refers to artificial intelligence and/or the field of studying methodology for making it. Machine learning is a field of studying methodologies that define and solve various problems dealt with in AI. Machine learning may be defined as an algorithm that enhances the performance of a task through a steady experience with any task.

An artificial neural network (ANN) is a model used in machine learning. It can mean a whole model of problem-solving ability, consisting of artificial neurons (nodes) that form a network of synapses. An ANN can be defined by a connection pattern between neurons in different layers, a learning process for updating model parameters, and/or an activation function for generating an output value. An ANN may include an input layer, an output layer, and optionally one or more hidden layers. Each layer may contain one or more neurons, and an ANN may include a synapse that links neurons to neurons. In an ANN, each neuron can output a summation of the activation function for input signals, weights, and deflections input through the synapse. Model parameters are parameters determined through learning, including deflection of neurons and/or weights of synaptic connections. The hyper-parameter means a parameter to be set in the machine learning algorithm before learning, and includes a learning rate, a repetition number, a mini batch size, an initialization function, etc. The objective of the ANN learning can be seen as determining the model parameters that minimize the loss function. The loss function can be used as an index to determine optimal model parameters in learning process of ANN.

Machine learning can be divided into supervised learning, unsupervised learning, and reinforcement learning, depending on the learning method. Supervised learning is a method of learning ANN with labels given to learning data. Labels are the answers (or result values) that ANN must infer when learning data is input to ANN. Unsupervised learning can mean a method of learning ANN without labels given to learning data. Reinforcement learning can mean a learning method in which an agent defined in an environment learns to select a behavior and/or sequence of actions that maximizes cumulative compensation in each state.

Machine learning, which is implemented as a deep neural network (DNN) that includes multiple hidden layers among ANN, is also called deep learning. Deep learning is part of machine learning. In the following, machine learning is used to mean deep learning.

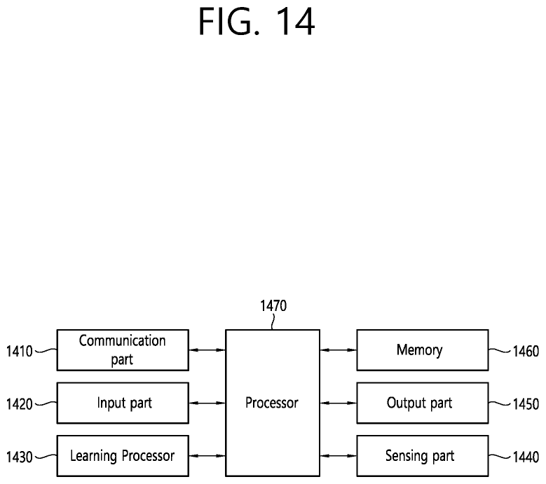

FIG. 14 shows an example of an AI device to which the technical features of the present specification can be applied.

The AI device 1400 may be implemented as a stationary device or a mobile device, such as a TV, a projector, a mobile phone, a smartphone, a desktop computer, a notebook, a digital broadcasting terminal, a PDA, a PMP, a navigation device, a tablet PC, a wearable device, a set-top box (STB), a digital multimedia broadcasting (DMB) receiver, a radio, a washing machine, a refrigerator, a digital signage, a robot, a vehicle, etc.

Referring to FIG. 14, the AI device 1400 may include a communication part 1410, an input part 1420, a learning processor 1430, a sensing part 1440, an output part 1450, a memory 1460, and a processor 1470.

The communication part 1410 can transmit and/or receive data to and/or from external devices such as the AI devices and the AI server using wire and/or wireless communication technology. For example, the communication part 1410 can transmit and/or receive sensor information, a user input, a learning model, and a control signal with external devices. The communication technology used by the communication part 1410 may include a global system for mobile communication (GSM), a code division multiple access (CDMA), an LTE/LTE-A, a 5G, a WLAN, a Wi-Fi, Bluetooth™, radio frequency identification (RFID), infrared data association (IrDA), ZigBee, and/or near field communication (NFC).

The input part 1420 can acquire various kinds of data. The input part 1420 may include a camera for inputting a video signal, a microphone for receiving an audio signal, and a user input part for receiving information from a user. A camera and/or a microphone may be treated as a sensor, and a signal obtained from a camera and/or a microphone may be referred to as sensing data and/or sensor information. The input part 1420 can acquire input data to be used when acquiring an output using learning data and a learning model for model learning. The input part 1420 may obtain raw input data, in which case the processor 1470 or the learning processor 1430 may extract input features by preprocessing the input data.

The learning processor 1430 may learn a model composed of an ANN using learning data. The learned ANN can be referred to as a learning model. The learning model can be used to infer result values for new input data rather than learning data, and the inferred values can be used as a basis for determining which actions to perform. The learning processor 1430 may perform AI processing together with the learning processor of the AI server. The learning processor 1430 may include a memory integrated and/or implemented in the AI device 1400. Alternatively, the learning processor 1430 may be implemented using the memory 1460, an external memory directly coupled to the AI device 1400, and/or a memory maintained in an external device.

The sensing part 1440 may acquire at least one of internal information of the AI device 1400, environment information of the AI device 1400, and/or the user information using various sensors. The sensors included in the sensing part 1440 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a light detection and ranging (LIDAR), and/or a radar.

The output part 1450 may generate an output related to visual, auditory, tactile, etc. The output part 1450 may include a display unit for outputting visual information, a speaker for outputting auditory information, and/or a haptic module for outputting tactile information.

The memory 1460 may store data that supports various functions of the AI device 1400. For example, the memory 1460 may store input data acquired by the input part 1420, learning data, a learning model, a learning history, etc.

The processor 1470 may determine at least one executable operation of the AI device 1400 based on information determined and/or generated using a data analysis algorithm and/or a machine learning algorithm. The processor 1470 may then control the components of the AI device 1400 to perform the determined operation. The processor 1470 may request, retrieve, receive, and/or utilize data in the learning processor 1430 and/or the memory 1460, and may control the components of the AI device 1400 to execute the predicted operation and/or the operation determined to be desirable among the at least one executable operation. The processor 1470 may generate a control signal for controlling the external device, and may transmit the generated control signal to the external device, when the external device needs to be linked to perform the determined operation. The processor 1470 may obtain the intention information for the user input and determine the user's requirements based on the obtained intention information. The processor 1470 may use at least one of a speech-to-text (STT) engine for converting speech input into a text string and/or a natural language processing (NLP) engine for acquiring intention information of a natural language, to obtain the intention information corresponding to the user input. At least one of the STT engine and/or the NLP engine may be configured as an ANN, at least a part of which is learned according to a machine learning algorithm. At least one of the STT engine and/or the NLP engine may be learned by the learning processor 1430 and/or learned by the learning processor of the AI server, and/or learned by their distributed processing. The processor 1470 may collect history information including the operation contents of the AI device 1400 and/or the user's feedback on the operation, etc. The processor 1470 may store the collected history information in the memory 1460 and/or the learning processor 1430, and/or transmit to an external device such as the AI server. The collected history information can be used to update the learning model. The processor 1470 may control at least some of the components of AI device 1400 to drive an application program stored in memory 1460. Furthermore, the processor 1470 may operate two or more of the components included in the AI device 1400 in combination with each other for driving the application program.

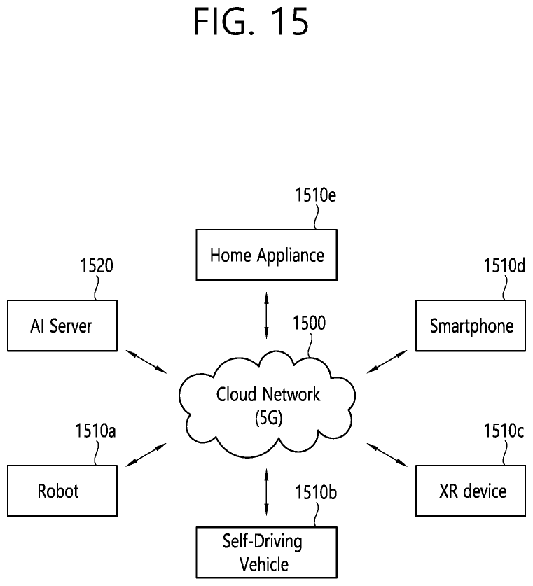

FIG. 15 shows an example of an AI system to which the technical features of the present specification can be applied.

Referring to FIG. 15, in the AI system, at least one of an AI server 1520, a robot 1510a, an autonomous vehicle 1510b, an XR device 1510c, a smartphone 1510d and/or a home appliance 1510e is connected to a cloud network 1500. The robot 1510a, the autonomous vehicle 1510b, the XR device 1510c, the smartphone 1510d, and/or the home appliance 1510e to which the AI technology is applied may be referred to as AI devices 1510a to 1510e.

The cloud network 1500 may refer to a network that forms part of a cloud computing infrastructure and/or resides in a cloud computing infrastructure. The cloud network 1500 may be configured using a 3G network, a 4G or LTE network, and/or a 5G network. That is, each of the devices 1510a to 1510e and 1520 consisting the AI system may be connected to each other through the cloud network 1500. In particular, each of the devices 1510a to 1510e and 1520 may communicate with each other through a base station, but may directly communicate with each other without using a base station.

The AI server 1520 may include a server for performing AI processing and a server for performing operations on big data. The AI server 1520 is connected to at least one or more of AI devices constituting the AI system, i.e. the robot 1510a, the autonomous vehicle 1510b, the XR device 1510c, the smartphone 1510d and/or the home appliance 1510e through the cloud network 1500, and may assist at least some AI processing of the connected AI devices 1510a to 1510e. The AI server 1520 can learn the ANN according to the machine learning algorithm on behalf of the AI devices 1510a to 1510e, and can directly store the learning models and/or transmit them to the AI devices 1510a to 1510e. The AI server 1520 may receive the input data from the AI devices 1510a to 1510e, infer the result value with respect to the received input data using the learning model, generate a response and/or a control command based on the inferred result value, and transmit the generated data to the AI devices 1510a to 1510e. Alternatively, the AI devices 1510a to 1510e may directly infer a result value for the input data using a learning model, and generate a response and/or a control command based on the inferred result value.

Various embodiments of the AI devices 1510a to 1510e to which the technical features of the present specification can be applied will be described. The AI devices 1510a to 1510e shown in FIG. 15 can be seen as specific embodiments of the AI device 1400 shown in FIG. 14.

For example, a wireless device can inform a network that a mobility to a cell which is no more applicable due to propagation delay is invalid.

For example, the wireless device can prevent additional CG change failure by not perform CG mobility to a cell which is no more applicable to perform CG change.

For example, CG change failure rate can be reduced and terminal service delay can be minimized by preventing improper mobility procedures due to propagation delays that can occur frequently due to satellite service.

Advantageous effects which can be obtained through specific embodiments of the present specification are not limited to the advantageous effects listed above. For example, there may be a variety of technical effects that a person having ordinary skill in the related art can understand and/or derive from the present specification. Accordingly, the specific effects of the present specification are not limited to those explicitly described herein, but may include various effects that may be understood or derived from the technical features of the present specification.

In the present specification, the term “I” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A, B, C” may mean “at least one of A, B, and/or C.”

Further, in the present specification, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present specification.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

What is claimed is:

1. A method performed by a wireless device in a wireless communication system, the method comprising:
triggering a measurement reporting based on a first event for a first cell;
receiving a cell group (CG) change command which commands CG change related to the first cell; and
determining whether the CG change command is valid or not based on the first event for the first cell and/or a second event for a second cell other than the first cell.

2. The method of claim 1, further comprising declaring a radio link failure (RLF) based on a determination that the CG change command is not valid.

3. The method of claim 2, further comprising performing a re-establishment procedure or a resume procedure after declaring the RLF.

4. The method of claim 1, further comprising rejecting the CG change command based on a determination that the CG change command is not valid, and
wherein the CG change related to the first cell is not performed.

5. The method of claim 4, further comprising transmitting information informing that the CG change related to the first cell is not performed to a network.

6. The method of claim 1, further comprising performing the CG change related to the first cell based on the CG change command, and
transmitting information informing that the first cell is no more proper to connect.

7. The method of claim 1, wherein the first cell is a target cell of the CG change.

8. The method of claim 7, wherein it is determined that the CG change command is not valid based on a leaving condition for the first event being satisfied for the first cell.

9. The method of claim 7, wherein the second cell is another neighbor cell other than the target cell of the CG change.

10. The method of claim 9, wherein it is determined that the CG change command is not valid based on an entering condition for the second event being satisfied for the second cell and consideration that the second cell is better to move than the first cell.

11. The method of claim 1, wherein it is determined that the CG change command is not valid based on a validity timer being running.

12. The method of claim 11, wherein the validity timer starts upon transmitting the measurement report.

13. The method of claim 1, wherein information on the first event and/or the second event is received from a network via a measurement configuration.

14. The method of claim 1, wherein the wireless device is in communication with at least one of a mobile device, a network, and/or autonomous vehicles other than the wireless device.

15. A wireless device in a wireless communication system, the wireless device comprising:
a memory;
a transceiver; and
a processor, operably coupled to the memory and the transceiver, wherein the wireless device is configured to:
trigger a measurement reporting based on a first event for a first cell,
receive a cell group (CG) change command which commands CG change related to the first cell, and
determine whether the CG change command is valid or not based on the first event for the first cell and/or a second event for a second cell other than the first cell.
